(19) United States
(12) Patent Application Publication
(10) Pub. No.: US 2026/0149558 A1
(43) Pub. Date: May 28, 2026

(54) FERROELECTRIC ASYNCHRONOUS INTERPOSER FOR PLASMA-MEDIATED HARDWARE ISOLATION AND ENTROPICALLY-BOUND ATTESTATION

(71) Applicant: Brian Terenna, Fort Myers, FL (US)

(72) Inventor: Brian Terenna, Fort Myers, FL (US)

(21) Appl. No.: 19/453,700

(22) Filed: Jan. 20, 2026

Related U.S. Application Data
(63) Continuation-in-part of application No. 19/452,335, filed on Jan. 18, 2026.

(51) Int. Cl. H04L 9/00; H10W 42/60; H10W 70/692

(52) U.S. Cl. CPC H04L 9/003; H10W 42/60; H10W 70/692

(57) ABSTRACT

A ferroelectric asynchronous interposer (100) for verifiable hardware isolation is disclosed. The system eliminates analog blindness via an autonomous physical-layer interdiction mechanism within a physically distinct Autonomous Galvanic Power Domain (AGPD) (200) decoupled from a host Power Management IC (204). Isolation is enforced by a Charge-Integrating Hysteresis Stack (106, 302) comprising four-terminal ferroelectric switches (HfZrO4). State verification is governed by thermodynamic accumulation of charge carriers in a reservoir (304) exceeding a Coercive Voltage (Vc). The interposer (100) utilizes a Variable Impedance Firewall via a Hybrid Isolation Mechanism, combining a Multi-Stage Cascaded Solid-State Plasma (SSP) element (222, 108a, 108b) and geometric impedance control (h≥3w) for a −100 dB isolation floor. Attestation is provided by a Truth Layer (230) generating a Quantum Liveness Witness (S≥2.4) utilizing Randomized Clock Dithering (606) and a Bandgap-Derived Bias Injection interlock (608) to neutralize cryogenic replay attacks.

### CROSS-REFERENCE TO RELATED APPLICATIONS

This application is a continuation-in-part of U.S. patent application Ser. No. 19/452,335, titled “Hardware-Enforced Sovereign Economic Succession System (SESS) Utilizing Analog Semantic Gating and Atomic Succession Protocols,” which provides a physical interdiction and autonomous galvanic interdiction mechanism for sovereign machine control. This application introduces novel ferroelectric asynchronous interdiction networks, plasma-mediated signal chokes, and temperature-dependent entropic-binding protocols not previously disclosed in the parent application.

### BACKGROUND OF THE INVENTION

The emergence of Ambient Intelligence (AmI) has resulted in the ubiquitous deployment of Always-Listening sensors and on-device Neural Processing Units (NPUs) within personal and industrial environments. Current privacy protocols rely predominantly on software-defined toggles or kernel-level permissions which are inherently reversible and vulnerable to privilege escalation. A compromised Operating System can programmatically spoof the “Off” state of a sensor while maintaining an active data stream—a failure of hardware trust known as “Analog Blindness” caused by the reliance on a shared power distribution network.

Furthermore, mechanical kill-switches known in the prior art are characterized as passive components that lack the capacity for verifiable cryptographic attestation, resulting in a state where the physical isolation cannot be mathematically bound to a digital session. Legacy mechanical switches are also vulnerable to machine-learning based acoustic forgery of actuation clicks and cryogenic entropy freezing techniques designed to simulate physical actuation events by reducing thermodynamic noise. Standard geometric optimizations in high-density interconnect (HDI) design typically provide only incremental improvements in electromagnetic isolation, failing to prevent signal leakage via substrate coupling.

It has been unexpectedly discovered that a Hybrid Isolation Mechanism, combining a vertical dielectric-to-trace-width ratio of h≥3w with solid-state conductivity modulation, establishes an Attained Attenuation Regime. This configuration forces electromagnetic field propagation into an Exponential Evanescent Decay (e\hat{ }(−αx)) profile, rather than a mere linear discontinuity, providing a verifiable −100 dB isolation floor required for high-assurance privacy. Consequently, there exists a critical need for a Charge-Integrating Hysteresis Stack that operates within a physically distinct Autonomous Galvanic Power Domain (AGPD) to enforce isolation as a thermodynamic default, independent of logical instruction sets.

### BRIEF SUMMARY OF THE INVENTION

The present invention provides a ferroelectric asynchronous interposer for verifiable hardware-enforced isolation. The system provides an autonomous, physical-layer interdiction mechanism that operates independently of a host processor instruction set via a physically distinct Autonomous Galvanic Power Domain (AGPD). The AGPD is physically decoupled from the host Power Management IC (PMIC) via a 100 micron dielectric trench and comprises a dedicated Low-Dropout Regulator (LDO), a charge reservoir, dedicated voltage regulator modules (VRMs), and on-chip transient suppression to prevent power-side channel attacks.

Interdiction within this domain is enforced by a Charge-Integrating Hysteresis Stack comprising a four-terminal ferroelectric switch utilizing Hafnium Zirconium Oxide (HfZrO4) gate dielectrics. State verification is governed by the non-volatile polarization of ferroelectric dipoles once the accumulated charge exceeds a specific Coercive Voltage (Vc), ensuring the interdiction is a direct consequence of Electron Transport Causality rather than clock-dependent logic. The apparatus achieves ultra-high signal isolation of at least −100 dB through a Variable Impedance Firewall utilizing a Hybrid Isolation Mechanism. This mechanism includes a Multi-Stage Cascaded Solid-State Plasma (SSP) Topology (configured as a T-Network or Pi-Network) to transition between a Conductive Plasma State (Signal ON) and a Depleted Dielectric State (Signal OFF), enforcing high-impedance isolation independent of mechanical contact distance.

The invention further provides a Truth Layer for quantum-hardened entropic attestation, utilizing a dedicated hardware Stochastic Logic Unit (SLU) to compute a session-unique Quantum Liveness Witness based on a violation of Bell's Inequality where S≥2.4. To neutralize memory loophole attacks, the system employs Randomized Clock Dithering driven by external environmental entropy. Additionally, a Bandgap-Derived Bias Injection interlock is configured such that the Bandgap Reference Voltage serves as the direct bias source for the entropy source; if the lattice temperature falls below −40 degrees Celsius, the bias voltage inherently collapses below the breakdown threshold, thereby neutralizing cryogenic replay attacks by rendering the generation of entropy physically impossible.

### BRIEF DESCRIPTION OF THE DRAWINGS

FIG. 1 is a perspective view of the ferroelectric asynchronous interposer, illustrating the Charge-Integrating Hysteresis Stack, the Multi-Stage Cascaded Solid-State Plasma choke elements, and the high-modulus glass core substrate.

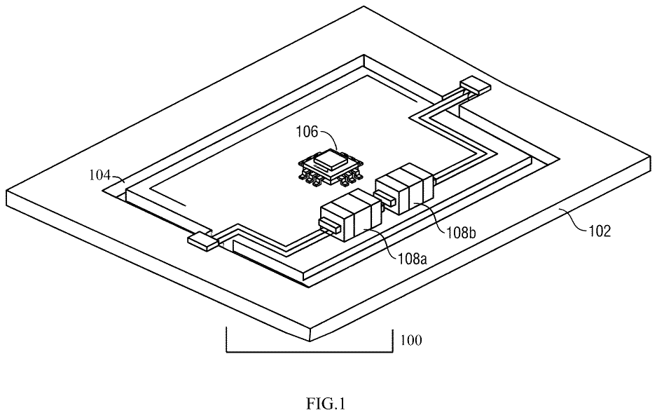

FIG. 2 is a high-level block diagram illustrating the systemic relationship between the Sentient, Physical, and Truth Layers within the Autonomous Galvanic Power Domain (AGPD).

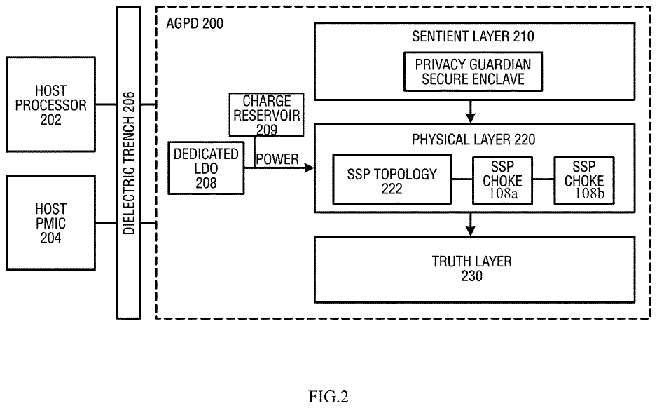

FIG. 3 is a schematic diagram of the Charge-Integrating Hysteresis Stack and the physically decoupled voltage regulator modules (VRMs).

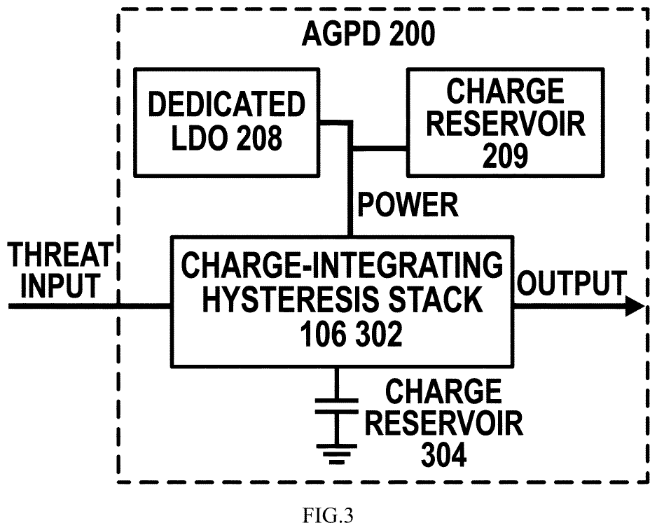

FIG. 4 is a flowchart depicting the hardware-enforced sequence of the Analog RC-Decay Latency Circuit.

FIG. 5 is a detailed cross-sectional view of the Variable Impedance Firewall highlighting the Hybrid Isolation Mechanism, the Metamaterial Absorbers, and the h≥3w geometric ratio.

FIG. 6 is a functional diagram of the Truth Layer, illustrating the Stochastic Logic Unit (SLU), the Randomized Clock Dithering circuit, and the Secure Sketch Fuzzy Extractor.

FIG. 7 is a cross-sectional view of the Industrial Hardening layer, showing the Active Capacitive Guard Ring, Sorbothane Potting, and Forensic Dissolution barriers.

### DETAILED DESCRIPTION OF THE INVENTION

The present invention is a hardware-implemented security apparatus embodied in a modular interposer 100 configured to enforce physical-layer privacy independently of a host device software state. The system functions as an autonomous interdiction mechanism located within a physically distinct Autonomous Galvanic Power Domain (AGPD) 200 isolated from the host processor 202 and host Power Management IC (PMIC) 204 via a 100 micron dielectric trench 104, 206. The AGPD 200 is physically decoupled and comprises a dedicated Low-Dropout Regulator (LDO) 208 and a charge reservoir 209 to ensure electrical unrecognizability to the host system. This isolation prevents power-side channel attacks and precludes software-based undervolting exploits.

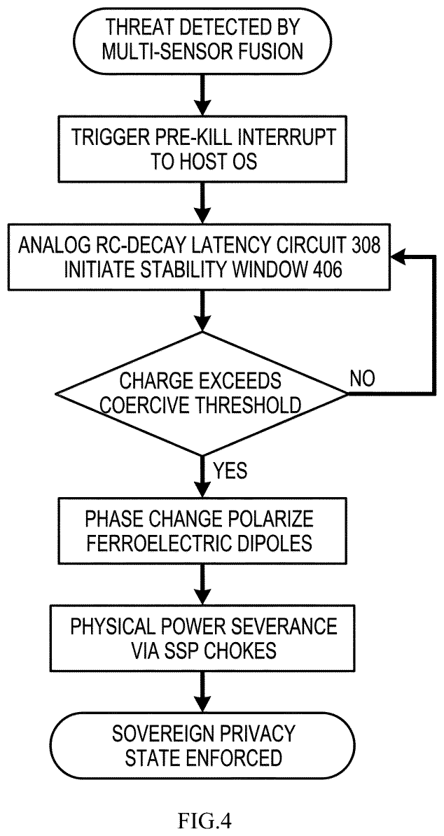

The Sentient Layer 210 identifies environmental threats via a Privacy Guardian Secure Enclave utilizing hard-wired multi-sensor fusion. Interdiction is implemented via a Charge-Integrating Hysteresis Stack 106, 302 comprising four-terminal ferroelectric switches utilizing Hafnium Zirconium Oxide (HfZrO4) as the gate dielectric. These switches enforce Electron Transport Causality, where the interdiction state is governed strictly by the thermodynamic accumulation of charge carriers in a charge reservoir 304 exceeding a Coercive Voltage (Vc). The state change is a material phase change triggered by the non-volatile polarization of crystal lattice dipoles within the HfZrO4. To manage buffer flushing following the interdiction sequence in FIG. 4, the system utilizes an Analog RC-Decay Latency Circuit 308 that relies on physical voltage decay (τ=RC) to enforce a 10 ms stability window 406 immune to system clock manipulation.

The Physical Layer 220 utilizes a Variable Impedance Firewall enforced by a Hybrid Isolation Mechanism. This mechanism includes a Multi-Stage Cascaded Solid-State Plasma (SSP) Topology 222 (configured as a T-Network or Pi-Network) utilizing SSP chokes 108a and 108b to transition between a Conductive Plasma State and a Depleted Dielectric State. This creates an impedance mismatch defined by the Multi-Stage Cascaded structure establishing a verifiable high-impedance floor exceeding 100 GOhms (>100 GΩ). In this isolated state, the power rail maintains this high-impedance floor via normally-on depletion-mode grounding shunts that provide a default grounded path for signal traces in the absence of gate bias.

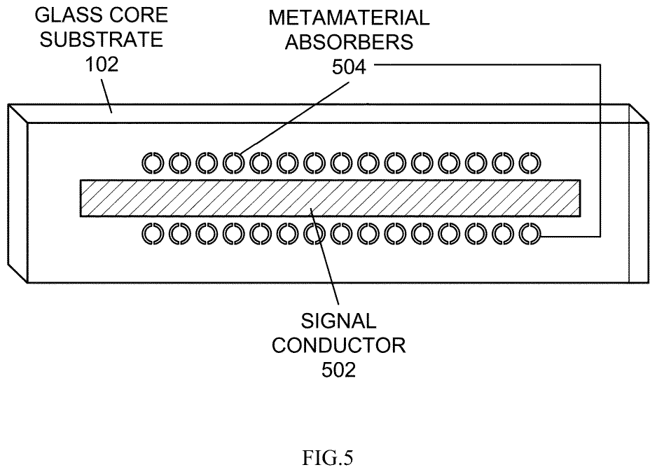

As shown in the cross-section of FIG. 5, signal leakage is prevented by a Geometric Impedance Control structure where the signal conductor 502 maintains a vertical dielectric-to-trace-width ratio of h≥3w. This ratio forces electromagnetic fields into an Attained Attenuation Regime characterized by Exponential Evanescent Decay (e\hat{ }-ax). This decay is further enhanced by Metamaterial Absorbers 504 (Split-Ring Resonators) embedded within the dielectric stack to nullify leakage emanations. To support these layers without thermomechanical warpage, the system mandates a High-Modulus Glass Core Substrate 102 with a Young's Modulus of at least 65 GPa.

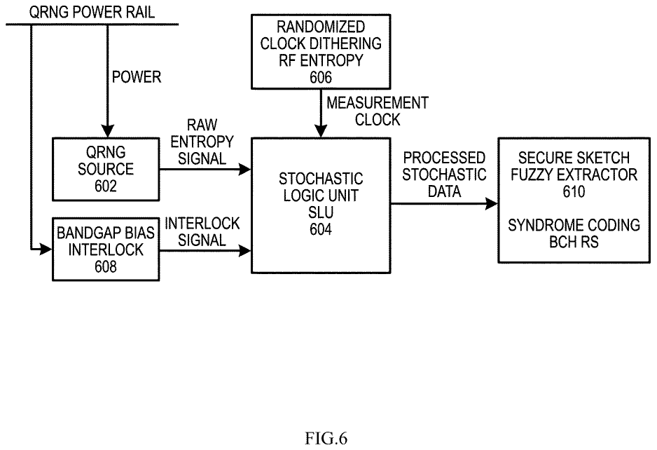

The Truth Layer 230, detailed in FIG. 6, provides mathematical proof that the physical state of the interposer is fresh and unforgeable. A dedicated hardware Stochastic Logic Unit (SLU) 604 utilizes a parallel accumulation pipeline to compute a session-unique Quantum Liveness Witness (S≥2.4). To prevent the “Memory Loophole,” the system employs Randomized Clock Dithering 606 driven by external RF background entropy. A Bandgap-Derived Bias Injection 608 serves as the direct bias source for the QRNG source 602; if the lattice temperature falls below −40° C., the bias voltage inherently collapses below the avalanche breakdown threshold, neutralizing cryogenic replay and “Localized Laser Heating” bypass attempts. Mechanical entropy from tribological jitter is stabilized by a Secure Sketch Fuzzy Extractor 610 utilizing Syndrome Coding (BCH or Reed-Solomon codes) to recover a stable witness.

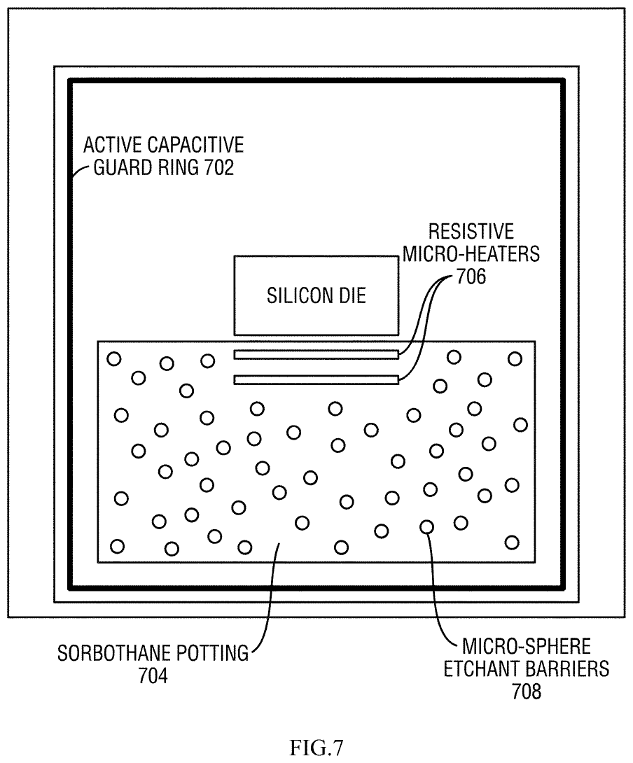

The apparatus incorporates Industrial Hardening via synergistic thermal and acoustic defenses. As shown in FIG. 7, this includes an Active Capacitive Guard Ring 702 to detect tampering. A Dynamic Capacitive Masking generator modulates the electric field potential with stochastic noise to bury contact bounce signatures below the Shannon limit. Acoustic protection is provided by mandatory Sorbothane potting 704 with a loss factor (tan δ) greater than 0.5 (tan δ>0.5) at frequencies above 20 kHz. Additionally, a Forensic Dissolution mechanism utilizes resistive micro-heaters 706 configured to melt micro-sphere etchant barriers 708, chemically dissolving the silicon die in response to a confirmed tamper event.

What is claimed is:

1. An autonomous hardware interposer (100) for sovereign signal isolation, comprising: an Autonomous Galvanic Power Domain (AGPD) (200) physically decoupled from a host Power Management IC (PMIC) (204) via a 100 micron dielectric trench (104, 206), the AGPD (200) comprising a dedicated Low-Dropout Regulator (LDO) (208), a charge reservoir (209), dedicated voltage regulator modules (VRMs) and on-chip transient suppression; a Charge-Integrating Hysteresis Stack (106, 302) comprising a four-terminal ferroelectric switch utilizing Hafnium Zirconium Oxide (HfZrO4) gate dielectrics configured to govern an interdiction state via a thermodynamic accumulation of charge carriers in a charge reservoir (304) exceeding a defined Coercive Voltage (Vc), wherein the interdiction state is determined strictly by a non-volatile polarization of ferroelectric dipoles independent of a host operating system clock; and a Variable Impedance Firewall coupled to the AGPD (200), configured to transition a signal path from a transmission characteristic impedance (Z0) to an isolation impedance exceeding a DC Resistance of 100 GOhms (>100 GΩ) in response to the polarization of the ferroelectric dipoles.

2. The autonomous hardware interposer of claim 1, further comprising an Analog RC-Decay Latency Circuit (308) connecting the Hysteresis Stack (106, 302) to the Variable Impedance Firewall, the circuit comprising a hardwired two-stage RC-delay network relying on physical voltage decay (τ=RC) to define a capacitor discharge curve providing a 10 ms stability window (406) for host buffer flushing prior to physical power severance.

3. The autonomous hardware interposer of claim 1, wherein the Variable Impedance Firewall is enforced by a Hybrid Isolation Mechanism selected from the group consisting of: (a) a Geometric Impedance Control structure having a vertical dielectric-to-trace-width ratio of h≥3w, configured to transition an electromagnetic field to an Attained Attenuation Regime characterized by Exponential Evanescent Decay (e\hat{ }(−αx)); (b) a Multi-Stage Cascaded Solid-State Plasma (SSP) Topology (222) (configured as a T-Network or Pi-Network) utilizing SSP chokes (108a, 108b) configured to transition between a Conductive Plasma State and a Depleted Dielectric State; and (c) a Metamaterial Resonance Shifting filter comprising sub-wavelength split-ring resonators (SRRs) (504) embedded within a dielectric stack.

4. The autonomous hardware interposer of claim 3, wherein the Multi-Stage Cascaded Solid-State Plasma Topology (222) is configured to provide an isolation floor of at least −100 dB when in the Depleted Dielectric State.

5. The autonomous hardware interposer of claim 1, further comprising a DC Impedance Anchor configured to shunt the signal path to a ground potential via normally-on depletion-mode grounding shunts when the AGPD (200) is in a de-energized state, thereby establishing a verifiable high-impedance floor exceeding 100 GOhms.

6. The autonomous hardware interposer of claim 1, further comprising an Integrated Supercapacitor Bank disposed within the AGPD (200), configured to store sufficient energy to execute the saturation of the ferroelectric dipoles and a forensic zeroization sequence in an absence of external primary power.

7. The autonomous hardware interposer of claim 1, further comprising a Privacy Guardian Secure Enclave (210) hardwired to the Charge-Integrating Hysteresis Stack (106, 302), the Enclave (210) utilizing multi-sensor fusion of RF fingerprinting and ultrasonic beacon analysis to autonomously trigger the accumulation of charge carriers.

8. The autonomous hardware interposer of claim 1, constructed upon a mandatory High-Modulus Substrate (102) comprising a glass core having a Young's Modulus of at least 65 GPa, configured to support a deep coaxial stripline geometry of the Variable Impedance Firewall without thermomechanical warpage.

9. The autonomous hardware interposer of claim 1, further comprising an Active Capacitive Guard Ring (702) enclosing the AGPD (200), configured to trigger the Charge-Integrating Hysteresis Stack (106, 302) upon detecting a 5% deviation in fringe-field capacitance.

10. The autonomous hardware interposer of claim 9, further comprising a Dynamic Capacitive Masking generator coupled to a shield electrode, configured to modulate an electric field potential with stochastic noise to render a contact bounce signature of the interposer statistically indistinguishable from background RF noise.

11. A variable impedance isolation apparatus for high-assurance privacy, comprising: a signal conductor (502) embedded within a dielectric stack; a Hybrid Isolation Mechanism coupled to the signal conductor (502), comprising a physical configuration selected from the group consisting of: (i) a Geometric Impedance Control having a vertical dielectric-to-trace-width ratio (h≥3w) configured to enforce an Exponential Evanescent Decay profile of electromagnetic fields; (ii) a Multi-Stage Cascaded Solid-State Plasma (SSP) modulator (222) configured to transition the signal conductor (502) between a Conductive Plasma State and a Depleted Dielectric State; and (iii) a Metamaterial Absorber (504) comprising sub-wavelength split-ring resonators; wherein the apparatus provides a signal isolation of at least −100 dB in an isolation state.

12. The apparatus of claim 11, further comprising a layer of viscoelastic material comprising Sorbothane potting (704) having a loss factor (tan δ) greater than 0.5 at frequencies above 20 kHz, configured to attenuate ultrasonic acoustic emissions by at least 40 dB, wherein the viscoelastic material is protected from cryogenic glass transition by a temperature-dependent interlock.

13. The apparatus of claim 11, further comprising a Forensic Dissolution mechanism comprising resistive micro-heaters (706) configured to melt micro-sphere etchant barriers (708) to chemically dissolve a silicon die of the apparatus in response to a tamper event.

14. A system for quantum-entropic attestation of hardware physical state, comprising: a Stochastic Logic Unit (SLU) (604) comprising a parallel accumulation pipeline; a Vernier Delay Line Time-to-Digital Converter (TDC) configured to generate raw entropy derived from a binary latch state; a Randomized Clock Dithering circuit (606) driven by external environmental entropy, configured to modulate a measurement clock of the SLU (604) to decouple a measurement from an internal state history of the system; and a Quantum Liveness Witness logic configured to verify that a measured CHSH parameter S exceeds a classical limit with a floor of S≥2.4.

15. The system of claim 14, wherein the Randomized Clock Dithering circuit (606) is driven by RF background static, thereby closing a memory loophole to prevent classical simulation of the Quantum Liveness Witness.

16. The system of claim 14, further comprising a Bandgap-Derived Bias Injection interlock (608), wherein a bandgap reference voltage serves as a direct bias source for a Quantum Random Number Generator (QRNG) diode (602), such that the bias source inherently collapses if a lattice temperature falls below −40 degrees Celsius.

17. The system of claim 14, further comprising a Tribological Jitter Stabilization unit utilizing Syndrome Coding (BCH or Reed-Solomon) via a Secure Sketch protocol (610) to stabilize mechanical entropy without leaking an atomic fingerprint.

18. The system of claim 14, further comprising a 256-bit Nonce-Interlock configured to fuse the Quantum Liveness Witness with a session-unique nonce and a value from a hardwired Monotonic Counter.
